(19) United States
(12) Patent Application Publication
(10) Pub. No.: US 2006/0213221 A1
(43) Pub. Date: Sep. 28, 2006

(54) Method and apparatus for generating a high pressure fluid

(76) Inventors: Ron Lee, Bloomsbury, NJ (US); Walter Whitlock, Chapel Hill, NC (US)

Correspondence Address: THE BOC GROUP, INC., 575 MOUNTAIN AVENUE, MURRAY HILL, NJ, 07974-2064, US

(21) Appl. No.: 11/088,050

(22) Filed: Mar. 23, 2005

(51) Int. Cl. F17C 9/02; F25J 1/00; F02C 3/10; F02C 6/00

(52) U.S. Cl. 62/606; 62/50.2

(57) ABSTRACT

An apparatus for generating a high pressure fluid from a low pressure gas source, includes a low pressure gas source for supplying a low pressure gas, a vessel for receiving the low pressure gas, cooling means for cooling the low pressure gas within the vessel to a condensation temperature sufficient to condense a desired portion of the low pressure gas into a liquid and for maintaining the temperature of the liquid during pressurization thereof; pressurizing means for pressurizing the liquid to yield a high pressure liquid, and optionally, treating means for treating the high pressure liquid to form a corresponding high pressure gas. The present invention is further directed to methods of generating a high pressure fluid.

### FIELD OF THE INVENTION

The present invention generally relates to a method and an apparatus for generating a high pressure fluid, more particularly to a method and an apparatus for generating a high pressure fluid from a low pressure gas source by condensing at least a portion of a low pressure gas to yield a condensate, and pressurizing the resulting condensate to produce a high pressure fluid which may be maintained as a high pressure liquid or further treated to form a high pressure gas.

### BACKGROUND OF THE INVENTION

Pressurized fluids including gases are used extensively in applications ranging from cryogenics to pneumatics. Pressurized fluids are typically generated through a mechanical gas compressor or a liquid pump. Gas compressors of this type are costly to maintain and operate and are not typically energy efficient. Furthermore, gas compressors frequently pose problems including contributing to the contamination of purified gases used to produce the pressurized fluids. Liquid pumps provide less than satisfactory performance especially when handling highly volatile liquids at low flow rates.

Accordingly, it would be an advance in the art of producing pressurized fluids to design an apparatus capable of efficiently generating a high pressure fluid (i.e., liquid or gas) from a low pressure gas source. Optionally, the apparatus is further capable of purifying the gas during processing. It would also be desirable to provide an apparatus, which is capable of condensing the low pressure gas to obtain a condensate, and thereafter pressurizing the condensate without triggering undesirable boil-off or flashing. It would be further desirable to provide an apparatus, which is capable of producing a high pressure fluid that is substantially free from contaminants and undesirable fluid components, thus enhancing the purity of the final product.

### SUMMARY OF THE INVENTION

The present invention is generally directed to a method and an apparatus for generating a high pressure fluid from a low pressure gas source. The apparatus of the present invention is designed to

The present invention is generally directed to a method and an apparatus for generating a high pressure fluid from a low pressure gas source. The apparatus of the present invention is designed to pressurize a low pressure gas in a simple and efficient manner which minimizes or eliminates ambient heat and substantially diminishes the presence of contaminants in the final product. By reducing ambient heat and pressure gradients, the occurrence of boil-off and flashing is substantially averted or eliminated. In addition, the present invention is applicable to the use of a low pressure gas source containing a mixture of gases in which it is desirable to extract less than all of the gases (i.e., a desired portion of the low pressure gas).

In accordance with one aspect of the present invention, there is provided an apparatus for generating a high pressure fluid from a low pressure gas source, which comprises:

a low pressure gas source for supplying a low pressure gas;

a vessel for receiving the low pressure gas;

cooling means for cooling the low pressure gas within the vessel to a condensation temperature sufficient to condense a desired portion of the low pressure gas into a liquid and for maintaining the temperature of the liquid during pressurization thereof;

pressurizing means for pressurizing the liquid to yield a high pressure liquid; and

optional treating means for treating the high pressure liquid to form a high pressure gas.

In one particular aspect of the present invention, there is provided an apparatus for generating a high pressure fluid from a low pressure gas source, which comprises:

a low pressure gas source for supplying a low pressure gas;

a vessel for receiving the low pressure gas;

a pressurizing assembly in fluid communication with the vessel; and

a cooling bath encompassing the vessel and the pressurizing assembly whereby the cooling bath cools the low pressure gas within the vessel to a temperature sufficient to condense a desired portion of the low pressure gas into a liquid and maintain the temperature of the liquid as it passes into the pressurizing assembly which applies pressure thereto to yield a high pressure liquid.

In another aspect of the present invention, there is provided a method for generating a high pressure fluid from a low pressure gas source which comprises:

cooling a low pressure gas supplied from the low pressure gas source to a temperature sufficient to condense a desired portion of the low pressure gas into a liquid;

extracting the liquid;

pressurizing the extracted liquid to a desired pressure to form a high pressure liquid while maintaining the condensation temperature of the high pressure liquid; and

optionally treating the high pressure liquid to form a corresponding high pressure gas.

### BRIEF DESCRIPTION OF THE DRAWINGS

The following drawings are illustrative of embodiments of the present invention and are not intended to limit the invention as encompassed by the claims forming part of the application.

FIG. 1 is a schematic diagram of an apparatus for generating a high pressure fluid for one embodiment of the present invention; and

FIG. 2 is a cross-sectional view of a pump as part of a pressurizing assembly used in the apparatus for one embodiment of the present invention.

### DETAILED DESCRIPTION OF THE INVENTION

The present invention is directed to a method and an apparatus for generating a high pressure fluid from a low pressure gas source. The apparatus of the present invention is designed to efficiently condense a low pressure gas, and pressurizing the resulting condensate with minimal vapor boil-off, flashing and contamination during processing. The present invention generally utilizes a process for cooling the gas sufficiently to condense it into a liquid, and maintaining the gas in liquid form throughout the pressurization process. Optionally the high pressure liquid may be further treated to produce a corresponding high pressure gas. In addition, the present invention may be adapted to enhance the purity of the condensate by utilizing the differences in condensation points between a desired portion of the low pressure gas and the unwanted components of the gas therein.

In one aspect of the present invention, there is provided an apparatus capable of cooling the low pressure gas sufficiently to yield a liquid or a condensate, and maintaining the temperature of the liquid throughout the subsequent pressurization process. In this manner, the condensate is stable and there is less ambient heat than in conventional processes, thereby minimizing unintended boil-off that may otherwise occur. Moreover, the apparatus of the present invention may utilize a particularly effective pressurizing assembly for compressing or pressurizing the resulting condensate. During operation, the pressurizing assembly pressurizes the liquid without causing undesirable pressure fluctuations, while generating little or no heat. This further enhances the stability of the condensate, which prevents undesirable boil-off and flashing. The pressurizing assembly also minimizes contamination of the condensate that typically occurs in conventional methods.

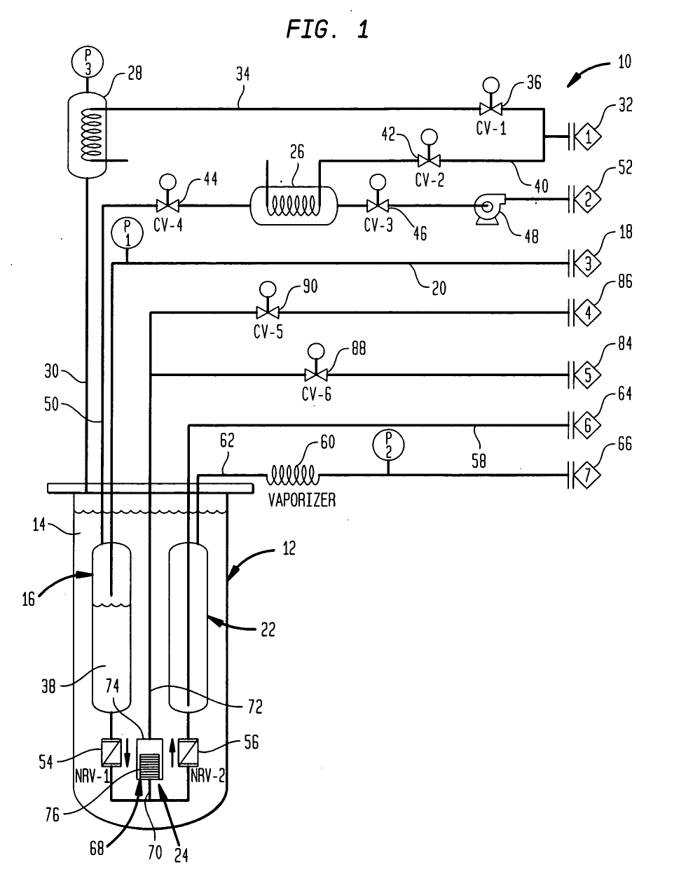

There is shown in FIG. 1 an embodiment of the apparatus 10 in accordance with the present invention. The apparatus 10 is adapted to generate a high pressure fluid from a low pressure gas source, while substantially minimizing undesirable contamination, boil-off and/or flashing. The high pressure fluid generated by the apparatus 10 will initially be a liquid but may be further treated as described hereinafter to produce a corresponding high pressure gas. The apparatus 10 utilizes a cooling means to condense the desired components of a low pressure gas into a liquid, and a pressurizing assembly adapted to compress or pressurize the liquid while substantially minimizing ambient heat and pressure gradients to obtain the final product. The combination of the cooling means and the pressurizing assembly means significantly reduces undesirable vapor boil-off and flashing.

The term “boil-off” refers to the vaporization of a volatile liquid such as, for example, liquid xenon, or liquid hydrogen, when the temperature reaches the boiling point. The term “flashing” refers to the vaporization of a volatile liquid such as, for example, liquid xenon, or liquid hydrogen, by the immediate presence of either heat or reduction by pressure.

The apparatus 10 generally includes a cooling bath vessel 12 containing a coolant 14 having a temperature below the condensation point of the desired portion of the low pressure gas and above its freezing point. The apparatus 10 further includes a condensation vessel 16 for receiving and holding a quantity of a low pressure gas from a low pressure gas source 18 via an inlet line 20, a receiving vessel 22 for receiving the condensed fluid from the condensing vessel 16, and a pressurizing assembly 24 for delivering the condensate from the condensation vessel 16 to the receiving vessel 22 and for pressurizing the condensate, each of which are located within the cooling bath vessel 12 and immersed in the coolant 14.

The coolant 14 may be selected from any suitable coolant substance including a liquid capable of remaining in liquid form at the desired condensation temperature and efficiently absorbing heat from a substrate including, but not limited to, tetrafluoromethane, hydrogen, argon, nitrogen, and carbon dioxide. The coolant 14 is preferably maintained at a temperature at which the desired portion of the low pressure gas begins to condense and above the temperature at which it begins to freeze. In one embodiment of the invention, the desired portion of the low pressure gas is xenon and the cooling bath is set at a pressure of about 3.1 bara, and at a temperature of about −111.0° C. which is above the freezing point of xenon (−111.8° C.). Gaseous xenon delivered to the condensation vessel 16 is preferably maintained at a pressure of at least 0.91 bara.

Optionally, the apparatus 10 may further include a gas separator 26 in communication with the condensation vessel 16, which is adapted for removing undesired gases and/or contaminants that may still be present in the low pressure gas as explained hereinafter.

In a preferred embodiment, the apparatus 10 includes a coolant condenser 28 which maintains the cooling temperature of the coolant 14 at a desirable temperature via a cooling line 30. The coolant condenser 28 is connected to a refrigerant source 32 via a condenser line 34 and a check valve 36. The refrigerant may be a cryogenic liquid such as liquid nitrogen and/or liquid helium. The cooled coolant 14 is circulated through the condenser 28 via the cooling line 30 to maintain the coolant 14 at the desired temperature.

The condensation vessel 16 is adapted to receive a quantity of low pressure gas from the low pressure gas source 18 via the inlet line 20. The low pressure gas is deposited in the condensation vessel 16 where it is cooled by the coolant 14 surrounding the condensation vessel 16. The desired portion of the low pressure gas has a condensation point that at least substantially matches the temperature of the coolant 14 and is therefore suitable for condensing the gas into a liquid or condensate 38. The condensate 38 is collected at the bottom portion of the condensation vessel 16. The undesirable portion of the low pressure gas (i.e., that portion of the gas mixture which is not immediately treated in accordance with the present invention) is present in gaseous form separate from the condensate 38. The undesirable portion may be vented through an exhaust line 50 for further processing as will be further described hereinafter.

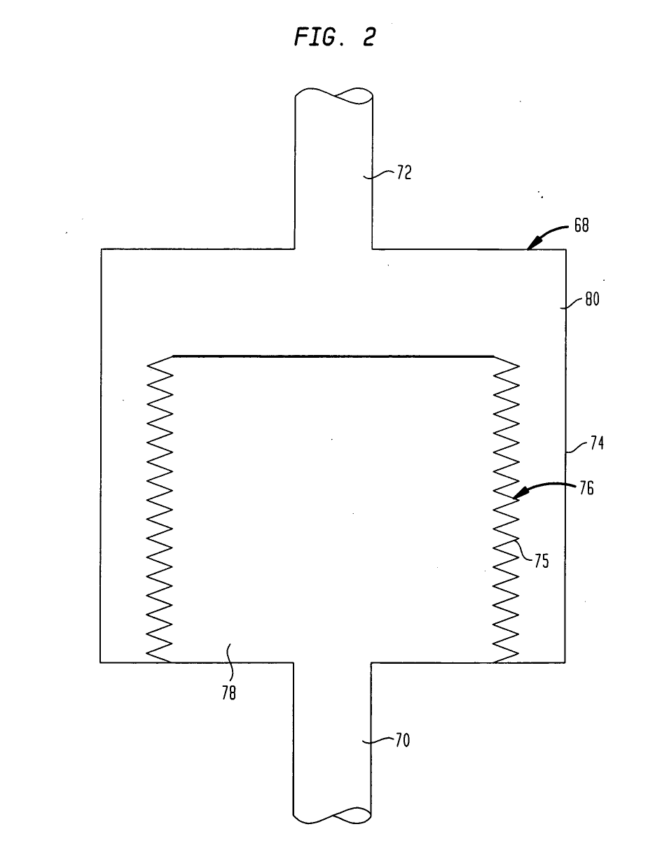

The condensate 38 is drawn from the bottom portion of the condensation vessel 16 by the pressurizing assembly 24. The pressurizing assembly 24 includes a pump 68 contained within a housing 74, a condensate conduit 70 at one end, a pneumatic conduit 72 connected to a high pressure pneumatic gas source 86 at the other end through a check valve 90, and a pressure generating device 76 referred hereinafter as a “bellows” within the housing 74 having accordion-like walls 75 defining a condensate area 78 (as shown best in FIG. 2). The pump 68 operates in a two phase cycle: an uptake phase and a discharge phase. During the uptake phase, the pump 68 draws the condensate 38 through the condensate conduit 70. During the discharge phase, the pump 68 expels the drawn condensate 38 out of the condensate conduit 70.

The apparatus 10 further comprises a first one-way valve 54 located between the condensation vessel 16 and the condensate conduit 70 of the pump 68, and a second one-way valve 56 located between the condensate conduit 70 of the pump 68 and the receiving vessel 22. The first and second valves 54 and 56 function to ensure that the flow of condensate induced by the pump 68 is directed exclusively from the condensation vessel 16 to the receiving vessel 22.

During the uptake phase of the pump 68, the condensate 38 is drawn from the condensation vessel 16, passes through the first one-way valve 54, and enters the pump 68 through the condensate conduit 70. During the discharge phase of the pump 68, the condensate 38 is expelled from the pump 68 through the condensate conduit 70. The condensate 38 is prevented from passing through the first one-way valve 54 into the condensation vessel 16, and is urged through the second one-way valve 56 into the receiving vessel 22. The pump 68 operates continuously in this manner to move the condensate 38 from the condensation vessel 16 to the receiving vessel 22 until the desired pressure is attained. The second one-way valve 56 prevents the condensate 38 in the receiving vessel 22 from returning to the pump 68.

Referring to FIG. 2 and FIG. 1, a preferred embodiment of the pressurizing assembly 24 including the pump 68 is shown. The pump housing 74 is sealed from the coolant 14 in the cooling bath. The bellows 76 is a collapsible casing partitioning the interior of the housing 74 into a condensate area 78 in fluid communication with the condensate conduit 70 and a pneumatic area 80 in fluid communication with the pneumatic conduit 72. The pneumatic conduit 72 is connected to a high pressure pneumatic source 84 regulated by a first pneumatic check valve 88, and to a pneumatic exhaust outlet 86 regulated by a second pneumatic check valve 90. The high pressure pneumatic source 84 supplies a pneumatic fluid to the pneumatic area 80. The pneumatic fluid has a pressure that is relatively higher than the condensate 38. The pneumatic fluid may typically be nitrogen gas or other suitable pneumatic fluid, which remains flowable at the temperature of the cooling bath.

When the first check valve 88 is opened and the second check valve 90 is closed, the pneumatic fluid is supplied to the pneumatic area 80 and exerts a pressure on the bellows 76. Since the pressure of the pneumatic fluid is greater than the pressure of the condensate area 78, the bellows 76 retracts towards the condensate conduit 70, and the condensate area 78 thereby contracts. When the first check valve 88 is closed and the second check valve 90 is opened, the pneumatic fluid is withdrawn from the pneumatic area 80 and the bellows 76 expands towards the pneumatic conduit 72 thereby displacing the pneumatic area 80. As the bellows 76 expands, the condensate 38 is drawn into the condensate area 38 from the condensation vessel 16. The second one-way valve 56 prevents the condensate 38 in the receiving vessel 22 from being drawn back into the condensate conduit 70.

When the pneumatic fluid is re-supplied to the pneumatic area 80, the pressure of the pneumatic fluid urges the bellows 76 toward the condensate conduit 70 where the condensate 38 is urged out of the pump 68. The expelled condensate 38 is prevented from passing through the first one-way valve 54, and flows through the second one-way valve 56 into the receiving vessel 22. This process continues until the desired pressure in the receiving vessel 22 is attained. When the pressure drops below a threshold level, the process is reconvened.

The pressurizing assembly of the present invention is designed to ensure that minimal heat is generated, thus preventing undesirable vapor boil-off. Further, the cooling bath provides an effective means for cooling and maintaining the pressurizing assembly and the condensate 38 at a low temperature, while providing a complete shield of the external heat load, which further serves to prevent vapor boil-off and flashing normally associated with pressure drops at the pump 68. The condensate 38 is maintained at a temperature sufficiently low to generate a net positive suction head (NPSH) at the pump 68. Preferably, this can be readily accomplished by keeping the coolant 14 at a temperature significantly below the saturation temperature of the condensate 38. The surrounding cooling bath serves a critical function by eliminating external heat transfer that may undesirably increase the temperature of the condensate 38, and further by maintaining the condensate 38 at a temperature sufficiently low to generate a net positive suction head at the pump 68.

Referring back to FIG. 1, if it is desired to form a pressurized gas, the pressurized condensate 38 in the receiving vessel 22 may be passed through a vaporizer 60 via an outlet line 62. The vaporizer 60 is a heat exchanger which raises the temperature of the condensate 38 sufficiently to vaporize it into a corresponding high pressure gas. As used herein, the phrase “corresponding high pressure gas” refers to the gas that is produced solely by changing the phase of the condensate under pressure in the receiving vessel 22. The resulting pressurized gas may then be dispensed through a gas outlet 66. If a pressurized liquid is desired, the pressurized liquid condensate 38 may be dispensed through a liquid outlet line 58 to a liquid outlet 64.

In one preferred embodiment of the present invention, an optional gas separator 26 can be employed to further extract trace amounts of the desired portion of the low pressure gas that may be still present therein. The gas separator 26 is a heat exchanger. During the condensation process in the condensation vessel 16, the partial pressure of the desired portion will drop to a point where further condensation is not possible, thereby leaving a trace amount of the desired portion of the low pressure gas in gaseous form. This trace amount of the desired portion can be extracted through the use of the gas separator 26.

The gas separator 26 is connected to the condensation vessel 16 and permits passage of the low pressure gas therethrough after the condensing process is completed. The gas separator 26 includes heat exchange surfaces, which are maintained at a temperature sufficient to collect and freeze the trace amount of the desired portion of the low pressure gas that comes in contact with the surfaces. The temperature of the heat exchange surfaces are maintained through the use of a refrigerant composed of a cryogenic liquid supplied from the refrigerant source 32 via a separator line 40 and a check valve 42.

After the condensation process is completed, the remaining low pressure gas which may contain trace amounts of the desired portion thereof is passed out of the condensation vessel 16 through an exhaust line 50 to the gas separator 26. As the low pressure gas contacts the cooler heat exchange surfaces of the gas separator 26, the trace amount of the desired portion of the low pressure gas freezes onto the heat exchange surfaces, while allowing the rest of the low pressure gas to pass therethrough. Once the low pressure gas is completely passed and vented out, the frozen desired portion of the low pressure gas collected in the gas separator 26 is melted to yield a liquid. The liquid is then extracted and deposited to the condensate 38 within the condensation vessel 16.

The gas separator 26 may operate in continuous flow mode or batch mode through operation of a front check valve 44 and a back check valve 46. In continuous mode, the front and back check valves 44 and 46 remain open and the low pressure gas from the condensation vessel 16 is vented through the gas separator 26. The desired portion of the low pressure gas freezes onto the heat exchange surfaces and the unwanted portion of the low pressure gas are exited out an exhaust 52 through a vacuum pump 48. In the batch mode, the back check valve 46 is opened and the front check valve 44 is closed to reduce the pressure in the gas separator 26. Thereafter, the back check valve 46 is closed and the front check valve 44 is opened, thereby allowing the low pressure gas to pass into the gas separator 26. When sufficient time has elapsed to allow the desired portion of the low pressure gas to be captured, the front check valve 44 is closed and the back check valve 46 is opened to allow the undesired portion of the low pressure gas to exit through the vacuum pump 48.

In both modes, the desired portion of the low pressure gas is recovered by closing the back check valve 46 and opening the front check valve 44 and elevating the temperature sufficiently to melt the desired portion of the low pressure gas which flows back down into the condensation vessel 16 via the exhaust line 50. The gas separator 26 may operate concurrently with the operation of the condensation vessel 16 and pressurizing assembly 24.

It is anticipated that other embodiments and variations of the present invention will become readily apparent to the skilled artisan in the light of the foregoing description and examples, and it is intended that such embodiments and variations likewise be included within the scope of the invention as set out in the appended claims.

What is claimed is:

1. An apparatus for generating a high pressure fluid from a low pressure gas source, comprising:
a low pressure gas source for supplying a low pressure gas;
a vessel for receiving the low pressure gas;
cooling means for cooling the low pressure gas within the vessel to a condensation temperature sufficient to condense a desired portion of the low pressure gas into a liquid and for maintaining the temperature of the liquid during pressurization thereof; and
pressurizing means for pressurizing the liquid to yield a high pressure liquid.

2. The apparatus of claim 1 further comprising treating means for treating the high pressure liquid to form a corresponding high pressure gas.

3. The apparatus of claim 1 wherein the cooling means maintains the liquid at a sufficiently low temperature to generate a net positive suction head at the pressurizing means.

4. The apparatus of claim 1 wherein the pressurizing means comprises a pressurizing assembly comprising a pump for transferring the liquid under pressure from the vessel.

5. The apparatus of claim 4 wherein the pump comprises a bellows.

6. The apparatus of claim 1 wherein the cooling means comprises a cooling bath encompassing the vessel and the pressurizing means.

7. The apparatus of claim 6 wherein the cooling bath comprises a liquid coolant.

8. The apparatus of claim 7 wherein the liquid coolant is selected from the group consisting of tetrafluoromethane, hydrogen, argon, nitrogen, and carbon dioxide.

9. The apparatus of claim 2 wherein the treating means comprises a heat exchanger.

10. An apparatus for generating a high pressure fluid from a low pressure gas source, the apparatus comprising:
a low pressure gas source for supplying a low pressure gas;
a vessel for receiving the low pressure gas;
a pressurizing assembly in fluid communication with the vessel; and
a cooling bath encompassing the vessel and the pressurizing assembly whereby the cooling bath cools the low pressure gas within the vessel to a temperature sufficient to condense a desired portion of the low pressure gas into a liquid and maintain the temperature of the liquid as it passes into the pressurizing assembly which applies pressure thereto to yield a high pressure liquid.

11. The apparatus of claim 10 wherein the cooling bath has a temperature sufficient to maintain the temperature of the liquid at a sufficiently low temperature to generate a net positive suction head at the pressurizing assembly.

12. The apparatus of claim 10 further comprising treating means for treating the corresponding high pressure liquid to form a corresponding high pressure gas.

13. A method for generating a high pressure fluid from a low pressure gas source, the method comprising the steps of:
cooling a low pressure gas supplied from the low pressure gas source to a temperature sufficient to condense a desired portion of the low pressure gas into a liquid;
extracting the liquid; and
pressurizing the extracted liquid to a desired pressure to form a high pressure liquid while maintaining the condensation temperature of the high pressure liquid.

14. A method according to claim 13 further comprising treating the high pressure liquid to form a corresponding high pressure gas.

15. The method of claim 13 wherein the extracting step further comprises removing any gas remaining in the low pressure gas.

16. The method of claim 15 further comprising:
cooling the remaining gas to a freezing temperature sufficient to freeze any trace amount of the desired portion of the low pressure gas which may be present therein; and
extracting the frozen desired portion of the low pressure gas.

17. The method of claim 14 wherein the treating step further comprises heating the high pressure liquid sufficiently to vaporize the high pressure liquid to yield the corresponding high pressure gas.

18. The method of claim 13 wherein the pressurizing step further comprises pumping the liquid into a volume until a desired pressure level is achieved.

19. The method of claim 13 further comprising maintaining the temperature of the extracted liquid prior to the pressurizing step at a temperature sufficient to generate a net positive suction head during pressurization step.
